(19) United States
(12) Patent Application Publication
(10) Pub. No.: US 2015/0148923 A1
(43) Pub. Date: May 28, 2015

(54) WEARABLE DEVICE THAT INFERS ACTIONABLE EVENTS

(71) Applicant: Lenovo (Singapore) Pte. Ltd., Singapore (SG)

(72) Inventors: Jason Grimme, Cary, NC (US); Rod D. Waltermann, Raleigh, NC (US); Peter Hamilton Wetsel, Raleigh, NC (US); Jonathan Gaither Knox, Morrisville, NC (US); Suzanne Marion Beaumont, Wake Forest, NC (US); Liang Chen, Raleigh, NC (US)

(73) Assignee: Lenovo (Singapore) Pte. Ltd., Singapore (SG)

(21) Appl. No.: 14/091,844

(22) Filed: Nov. 27, 2013

(51) Int. Cl. G05B 15/02

(52) U.S. Cl. CPC G05B 15/02
USPC 700/83

(57) ABSTRACT

An embodiment provides a method, including: collecting, in a passive state of a wearable information handling device, one or more sensor inputs via a sensor of the wearable information handling device; mapping, using a processor, the one or more sensor inputs to one of a plurality of predetermined events; and executing, using the processor, a predetermined action based on the mapping. Other aspects are described and claimed.

### BACKGROUND

Wearable information handling devices (“devices), e.g., smart watches, arm bands, gloves, etc., are becoming increasingly popular. Many parts of the body move and thus the form of wearable devices continues to expand. Wearable devices capable of motion detection exist. Conventional wearable devices may be activated by a user and thereafter accept various inputs (e.g., manual inputs, motion inputs, etc.) to effect various functionality, e.g., controlling of a game, manipulating on-screen content, etc.

### BRIEF SUMMARY

In summary, one aspect provides a method, comprising: collecting, in a passive state of a wearable information handling device, one or more sensor inputs via a sensor of the wearable information handling device; mapping, using a processor, the one or more sensor inputs to one of a plurality of predetermined events; and executing, using the processor, a predetermined action based on the mapping.

Another aspect provides a wearable information handling device, comprising: a sensor; a processor; and a memory device storing instructions executable by the processor to: collect, in a passive state of the wearable information handling device, one or more sensor inputs via the sensor; map the one or more sensor inputs to one of a plurality of predetermined events; and execute a predetermined action based on the mapping.

A further aspect provides a wearable information handling device, comprising: a display device; a sensor; a processor operatively coupled to the sensor and the display device; and a memory device storing instructions executable by the processor to: a memory device storing instructions executable by the processor to: collect, in a passive state of the wearable information handling device, one or more sensor inputs via the sensor; map the one or more sensor inputs to one of a plurality of predetermined events; and execute a predetermined action based on the mapping.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of an information handling device.

FIG. 3 illustrates an example method of using a wearable device to infer actionable events.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Many parts of the body move in response to particular events that if not captured and analyzed automatically may otherwise go unnoticed and lack a response or fail to produce an output. Wearable devices capable of motion detection exist but these conventional wearable devices must be used deliberately, e.g., to capture the motion. That is, such wearable devices must be in the user's hand to use or otherwise intentionally activated. Such wearable devices might not be readily available, enabled, or on the person at the time an interesting motion event occurs. By requiring intentional use, many motions therefore go unnoticed or are otherwise disregarded by conventional wearable devices. This is unfortunate because a wearable device is typically always or often worn by the user, even when not actively or intentionally being used.

Accordingly, an embodiment provides a wearable device that intelligently self activates such that interesting events may be detected/sensed and acted upon or otherwise utilized. This allows motions that are both intentional and unintentional to be captured, analyzed, and responded to. For example, according to an embodiment, a wearable device detects a fall, a hand gesture, the raising of a hand, the snapping of a finger, etc., even if the user has not intentionally or consciously activated the wearable device. Thus, such detected events (e.g., motions, muscle activities, audible inputs, etc.) may be analyzed in real time or stored for later processing, e.g., compared to known signatures, events, or patters, to determine corresponding event handlers, actions, functions and/or outputs.

The illustrated example embodiments will be best understood by reference to the figures. The following description is intended only by way of example, and simply illustrates certain example embodiments.

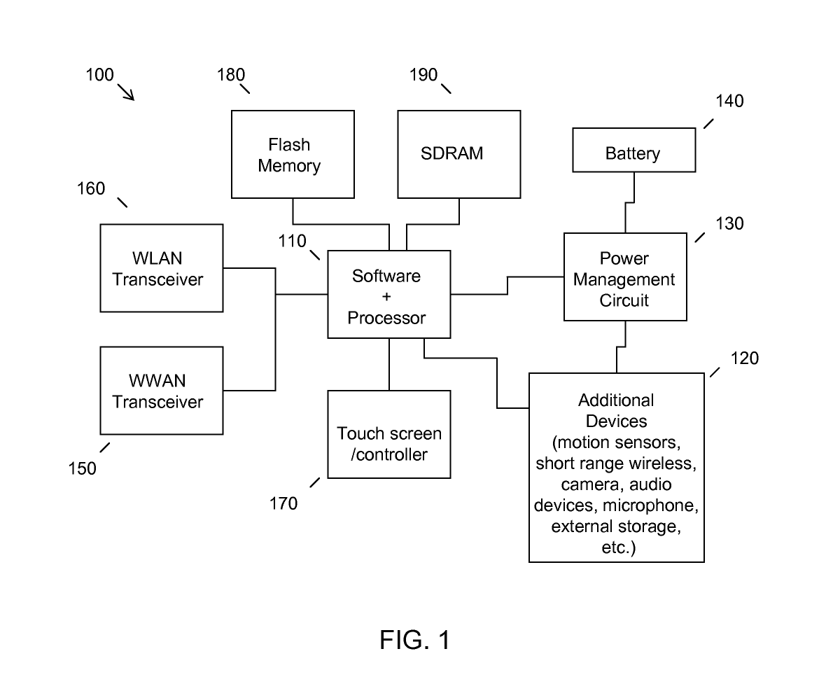

While various other circuits, circuitry or components may be utilized in information handling devices, with regard to wearable devices, smart phones and/or tablet circuitry 100, an example illustrated in FIG. 1 includes a system on a chip design found for example in tablet or other mobile computing platforms. Software and processor(s) are combined in a single chip 110. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces for example include SDIO and I2C.

There are power management chip(s) 130, e.g., a battery management unit, BMU, which manage power as supplied for example via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, one of the additional devices 120 is commonly a short range wireless communication device, such as a BLUETOOTH radio, or element(s) that may be used for near field communications. Commonly, system 100 will include a touch screen 170 for data input and display. System 100 also typically includes various memory devices, for example flash memory 180 and SDRAM 190.

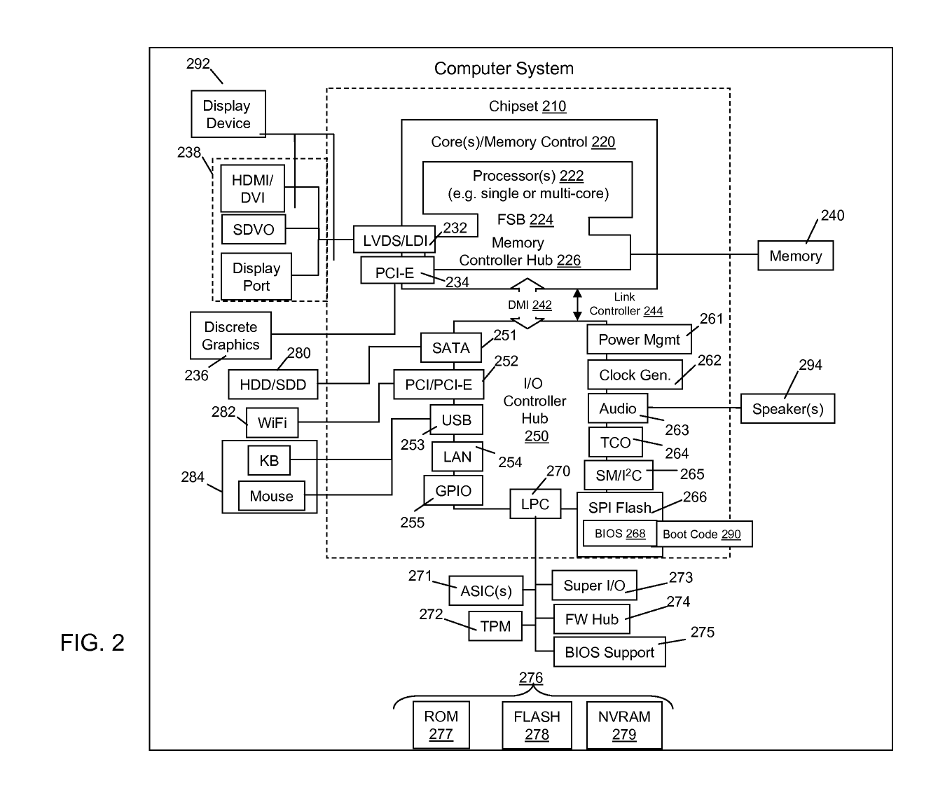

FIG. 2, for its part, depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). The architecture of the chipset 210 includes a core and memory control group 220 and an I/O controller hub 250 that exchanges information (for example, data, signals, commands, et cetera) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, et cetera). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, 280 et cetera), a PCI-E interface 252 (for example, for wireless connections 282), a USB interface 253 (for example, for devices 284 such as a digitizer, keyboard, mice, cameras, phones, microphones, storage, other connected devices, et cetera), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be utilized in various devices according to the embodiments described herein. For example, the circuitry outlined in FIG. 1 may be utilized in a wearable device and the circuitry outlined in FIG. 2 may be used in another device in communication with the wearable device, e.g., a cloud based device, a laptop device, a tablet device, etc. For example, a wearable device may include circuitry similar to that outlined in FIG. 1 and communicate, e.g., using a short range wireless device such as a BLUETOOTH LE device, a near field communication device, or other communication mechanisms, e.g., a network connection, with other devices, e.g., a local or remote device including circuitry such as outlined in FIG. 2.

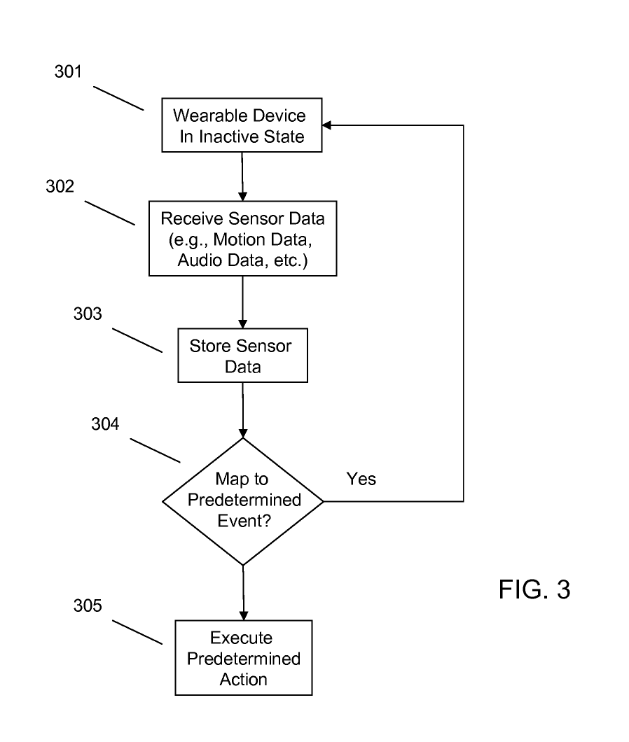

Referring to FIG. 3, in an embodiment, a wearable device (e.g., smart watch, bracelet, glove, etc.) may be worn by a user. The wearable device detects and captures user's motions and other data via sensor(s). In an embodiment, the wearable device does this monitoring or sensing even if the wearable device is in an inactive or passive state 301, e.g., when the wearable device is in sleep mode, low power mode, the display device is powered off or locked, etc. Accordingly, while the wearable device is in an inactive or passive mode 301 and not being used by a user, it nonetheless continues to receive sensor data at 302. This may be accomplished in a variety of ways, for example including in the wearable device an always active or always on sub-system or collection of components, e.g., sensor(s), processor(s), memory, etc., that may continue to operate at very low power or passive mode.

It should be noted that a variety of sensors may be included. For example, the wearable device may include an accelerometer, a microphone, muscle and/or skin activity sensors, etc., such that a wide range sensor inputs are available to trigger a correspondingly wide range of functions or actions, as further described herein.

Referring again to FIG. 3, an embodiment may store this sensor input data at 303, for example in a memory of the wearable device and/or at another location, e.g., a device in communication with the wearable device. The storage of the sensor input data at 303 may be temporary, persistent, or a combination of the foregoing. For example, in a real-time or near real-time user context, the sensor input data may be temporarily stored and quickly processed/analyzed. Additionally or in the alternative, the sensor input data may be stored for later analysis, e.g., by the wearable device and/or other devices in communication with the wearable device. For example, sensor data that is stored at 303 may be utilized almost immediately to execute predetermined actions, as further described herein, and/or the sensor data may be stored for later processing, e.g., to refine mappings, predetermined actions, etc., either locally at the wearable device or at another device in communication with the wearable device.

Given that the wearable device is collecting sensor data and storing the same, even though a user may not be actively using the wearable device (e.g., intentionally interfacing with the wearable device, intentionally executing motion commands with the wearable device, etc.), this inactive state sensor data may be analyzed to ascertain or infer a predetermined event has occurred. By way of example, the wearable device may analyze the sensor input data at 304 in an effort to map sensor input(s) to predetermined events, e.g., as characterized by pattern(s) in the sensor input data. This analysis or mapping may be done at a variety of times, e.g., continuously (or nearly so), according to a policy, e.g., at predetermined times, with a predetermined frequency, in response to another predetermined event, etc.

If the wearable device is able to map the sensor input(s) to a predetermined event, as further described herein, the wearable device may execute a predetermined action at 305. Otherwise, the wearable device may continue to receive sensor inputs and iterate through the process of attempting to identify an event that calls the wearable device to action in some way.

By way of example, if the wearer of the user device is walking and not actively using the wearable device, according to an embodiment the wearable device nonetheless receives sensor data at 302. This may include motion data, heart rate data, temperature data (e.g., ambient, skin temperature), etc. If the user falls, although the wearable device is still “inactive”, the device nonetheless will receive sensor data at 302 and store the same at 303 that is indicative of this event, e.g., abrupt perturbation in the accelerometer data, heart rate data, etc. The wearable device for example may detect a fall event using an accelerometer to detect the fall as a sudden acceleration/deceleration pattern in sensor data input. Given this ability, an embodiment may map this sensor input data pattern to a predetermined fall event at 304 and execute a predetermined action at 305, e.g., sending a communication to an emergency service, even though the user never “activates” the wearable device.

The mapping of the sensor data at 304 and/or the predetermined action executed at 305 may be refined accordingly. For example, the accelerometer data may be analyzed to gauge the severity of the impact, which then may be used in conjunction with a secondary analysis (e.g., analysis of pulse data, moisture data, etc.) to detect if the owner is in a state of shock, unconsciousness, etc. Thus, a predetermined action may be a further iteration through the mapping/analysis steps, using additional sensor data, and/or may include activating additional sensors to appropriately categorize an initial mapping/analysis. Moreover, the refinement may impact the mapping, e.g., the predetermined communication or other action may be modified, cancelled, etc., given additional sensor data and analysis thereof.

As another example, a student with a wearable device may raise his or her hand. The wearable device, although in an inactive state at 301, uses an accelerometer to detect the motion at 302, and thereafter determine the raised hand event at 304. As an example execution of a predetermined action executed at 305, the teacher or instructor may be notified, e.g., in the form of an automated communication to the teacher or instructor wearable device sent from the student's wearable device. Thus, the teacher or instructor, even if not facing the student, nonetheless may be notified of the hand raising event, e.g., via a haptic feedback on the teacher or instructor wearable device.

Different refinements may be utilized in this regard on the receiving side, i.e., the teacher or instructor wearable device, for example the order in which multiple student wearable device communications were received (i.e., which student has a raised hand and also which of multiple students raising their hands raised their hand first). As another example, the receiving wearable device may receive communications and thereafter respond. For example, the teacher or instructor could notice some students talking. This may be noticed via the students' wearable devices, e.g., audio sensors, sending a notification to the teacher's wearable device, or the teacher may notice this event independent of wearable device communication. In any event, in order to not disturb the other students, the teacher may send a signal or communication to the students' wearable devices, e.g., notifying the talking students by activating their haptic feedback mechanisms resident on their wearable devices, e.g., to indicate that they should be quiet.

Other types of sensor input data may be collected. For example, the sensor input data may include audio data. Thus, a wearable device display may be in an inactive state in which it has its display disabled. If the wearer of the wearable device snaps his or her fingers, this may be perceived (e.g., via audio data received by a sensor of the wearable device and/or motion data sensed by the wearable device). In response to mapping this sensor data, e.g., mapping the snapping audio data to a finger snap audio signature, a predetermined action may be executed, e.g., activation of the device display.

Additionally, sensor input data may be utilized to modify the mapping and/or predetermined action in addition to detecting the event. For example, if two users of wearable devices shake hands at a conference, a wearable device of one user may detect a hand shaking gesture, e.g., by using accelerometer data to detect a hand shaking motion. This may be mapped to a hand shake event, e.g., via a pattern in the accelerometer data and/or muscle activity sensor data. Moreover, the wearable devices may sense proximity to one another, e.g., via short range wireless or near field communication mechanisms. Thus, in addition to detecting an event, i.e., a hand shake event in this example, the wearable devices may additionally sense addressing data, e.g., of the other proximate device.

Therefore, a predetermined event may be detected and mapped to an action, e.g., sending contact information, as well as a modification or addition to the predetermined event, e.g., the addressing information needed to complete the predetermined action. In this example, after the greeting handshake, the wearable devices may exchange and store/record contact information, and/or record the time and place of the greeting for historical purposes, etc.

As may be appreciated from the foregoing examples, embodiments provide wearable devices that leverage data that, in conventional contexts, goes un-sensed or unnoticed even if sensed. Therefore, although a wearable device may not be actively in use by a user, it may nonetheless be utilized to collect interesting and useful information, e.g., via on-board sensors that consume only a small amount of power. By implementing an intelligent analysis of this sensor data, the various embodiments permit a wide range of additional functionality for wearable device users, even if the wearable device user is not consciously aware that an interesting event has or is about to take place.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
collecting, in a passive state of a wearable information handling device, one or more sensor inputs via a sensor of the wearable information handling device;
mapping, using a processor, the one or more sensor inputs to one of a plurality of predetermined events; and
executing, using the processor, a predetermined action based on the mapping.

2. The method of claim 1, further comprising activating the wearable information handling device responsive to the mapping.

3. The method of claim 1, wherein:
the sensor input comprises motion data;
the mapping comprises mapping the motion data to a fall event; and
the predetermined action comprises collecting data of an additional sensor.

4. The method of claim 1, wherein:
the sensor input comprises motion data and device addressing data;
the mapping comprises mapping the motion data to a hand shake event; and
the predetermined action comprises sending a message comprising contact information to a location according to the device addressing data.

5. The method of claim 1, wherein:
the sensor input comprises motion data;
the mapping comprises mapping the motion data to a hand raising event; and
the predetermined action comprises sending a message to a predetermined device.

6. The method of claim 1, wherein:
the sensor input comprises audio data;
the mapping comprises mapping the audio data to a predetermined audio command; and
the predetermined action comprises activating a display device of the wearable information handling device.

7. The method of claim 1, wherein the sensor comprises one or more of an accelerometer, a microphone and a muscle activity sensor.

8. The method of claim 1, further comprising:
receiving, in the passive state, a communication from another device; and
executing a predetermined action responsive to the communication.

9. The method of claim 8, wherein the predetermined action comprises haptic feedback.

10. The method of claim 1, wherein:
the sensor input comprises audio data; and
wherein the predetermined action comprises sending a notification to a predetermined location.

11. A wearable information handling device, comprising:
a sensor;
a processor; and
a memory device storing instructions executable by the processor to:
collect, in a passive state of the wearable information handling device, one or more sensor inputs via the sensor;
map the one or more sensor inputs to one of a plurality of predetermined events; and
execute a predetermined action based on the mapping.

12. The wearable information handling device of claim 11, wherein the instructions are further executable by the processor to activate the wearable information handling device responsive to the mapping.

13. The wearable information handling device of claim 11, wherein:
the sensor input comprises motion data;
to map comprises mapping the motion data to a fall event; and
the predetermined action comprises collecting data of an additional sensor.

14. The wearable information handling device of claim 11, wherein:
the sensor input comprises motion data and device addressing data;
to map comprises mapping the motion data to a hand shake event; and
the predetermined action comprises sending a message comprising contact information to a location according to the device addressing data.

15. The wearable information handling device of claim 11, wherein:
the sensor input comprises motion data;
to map comprises mapping the motion data to a hand raising event; and
the predetermined action comprises sending a message to a predetermined device.

16. The wearable information handling device of claim 11, wherein:
the sensor input comprises audio data;
to map comprises mapping the audio data to a predetermined audio command; and
the predetermined action comprises activating a display device of the wearable information handling device.

17. The wearable information handling device of claim 11, wherein the sensor comprises one or more of an accelerometer, a microphone and a muscle activity sensor.

18. The wearable information handling device of claim 11, wherein the instructions are further executable by the processor to:
receive, in the passive state, a communication from another device; and
execute a predetermined action responsive to the communication.

19. The wearable information handling device of claim 18, wherein the predetermined action comprises haptic feedback.

20. A wearable information handling device, comprising:
a display device;
a sensor;
a processor operatively coupled to the sensor and the display device; and
a memory device storing instructions executable by the processor to:
a memory device storing instructions executable by the processor to:
collect, in a passive state of the wearable information handling device, one or more sensor inputs via the sensor;
map the one or more sensor inputs to one of a plurality of predetermined events; and
execute a predetermined action based on the mapping.
